(19) United States
(12) Patent Application Publication
(10) Pub. No.: US 2024/0407973 A1
(43) Pub. Date: Dec. 12, 2024

(54) Oral Medicine Administration Spoon

(71) Applicant: Marcella Thompson, Danbury, TX (US)

(72) Inventor: Marcella Thompson, Danbury, TX (US)

(21) Appl. No.: 18/736,614

(22) Filed: Jun. 7, 2024

Related U.S. Application Data
(60) Provisional application No. 63/506,695, filed on Jun. 7, 2023.

(51) Int. Cl. A61J 7/00; A61J 7/04

(52) U.S. Cl. CPC A61J 7/0023; A61J 7/04

(57) ABSTRACT

A medicine administration spoon for oral administration of a medicine. The spoon includes a bowl or spoon member for accommodating medicine, the bowl or spoon member is concave and includes a plurality of dose slit lines. The dose slit lines provide a visual aid for different dose amounts. A dose timer member has a needle whose pointed end can be turned and pointed in a specific direction to indicate the next dose timing. The bowl or spoon member includes a contoured periphery including curves, wherein the medicine is administered using one of the curves depending on the position such as supine, sitting, or moving of the patient. The spoon can be used for any type of oral medicine and reduces spilling of medicine.

### CROSS-REFERENCE TO RELATED APPLICATION

The present application claims priority to, and the benefit of, U.S. Provisional Application No. 63/506,695, which was filed on Jun. 7, 2023, and is incorporated herein by reference in its entirety.

### FIELD OF THE INVENTION

The present invention generally relates to the field of medicine administering devices. More specifically, the present invention relates to a novel oral medicine administration spoon. The spoon can accommodate a liquid medicine on a bowl or spoon member and the bowl or spoon member includes dose indication lines for helping in measuring the medication dose. A dose timer is included in the spoon for indicating the next dose timing. The spoon can be used for giving medicine to a patient regardless of the position such as supine, sitting, inclined, and/or while moving of the patient. Accordingly, the present disclosure makes specific reference thereto. Nonetheless, it is to be appreciated that aspects of the present invention are also equally applicable to other like applications, devices, and methods of manufacture.

### BACKGROUND

By way of background, oral medication is necessary for almost all health-related treatments. Typically, oral medication includes swallowing a tablet or capsule with water but for children and elderly people, oral medication commonly includes a suitable liquid or syrup. Medicated liquid is administered by a spoon or any other similar device. Children often do not sit up straight or stay still for medication administration. Children may resist, or be unable to maintain a proper position, making it difficult for caregivers to administer medication accurately. The elderly, especially those with mobility issues or cognitive impairments, also struggle with sitting up straight. They might have difficulty holding their heads steady or maintaining a suitable posture for taking medication.

As a result, when administering medication to children and elderly people, medication misses the patient's mouth and is often spilled onto their face, clothing, and surrounding areas. Spilling causes wastage of medication and creates hygiene concerns. Patients and caregivers desire an improved oral medication administering device that can be used to give medication to patients irrespective of the posture of the patients.

Memory issues or cognitive decline can make it difficult for elderly individuals or their caregivers to remember the schedule to administer medication. Similarly, caregivers for children may forget the exact time or dosage schedule for administering medication. Missing doses of medication can lead to inadequate treatment of the medical condition. Especially, missing doses of critical and life-saving medications can potentially lead to worsening chronic conditions. Commonly, caregivers use alarms on their smartphones to maintain a schedule of the next dose but this can be ineffective especially when multiple caregivers look after a patient such as in a medical facility. Patients and caregivers desire a simple way to identify the time for next dose administration.

Many times, patients are given inaccurate volume of medication due to a lack of precise dose volume tools. People commonly use spoons to administer oral medication but conventional spoons do not have any dose volume markings. As a result, patients are administered dosages with either less or more medication than prescribed.

Therefore, there exists a long-felt need in the art for a liquid medication administering device that allows easy administration of liquid medicine. Additionally, there is a long-felt need in the art for a spoon specially designed to administer liquid medication to individuals who are in different positions. Moreover, there is a long-felt need in the art for an oral medication administration spoon that includes a clock face to visually aid patients and caregivers to keep track of the next medication dose. Further, there is a long-felt need in the art for a liquid medication administration spoon that reduces spilling of medication on clothing and face of the patient. Furthermore, there is a long-felt need in the art for an oral medication administration spoon that indicates dose volume for precise medication administration. Finally, there is a long-felt need in the art for a liquid medication administration spoon that allows liquid medication administration to patients who are in a sitting up, a supine, or a mobile position while reducing the chances of spilling of medication by providing different contoured sides for easy administration.

The subject matter disclosed and claimed herein, in one embodiment thereof, comprises a medicine administration spoon. The spoon is used for administering medicine to a patient regardless of the position of the patient. The spoon includes an elongated handle and a concave bowl or spoon member integrated at one end of the handle, the concave bowl or spoon member is used for accommodating medication for oral administration. The concave bowl or spoon member features an elliptical-spoon-shaped periphery with curved contoured peripheral edges for safely administering medicine. A medication administration dose timer member is integrated at the opposing end of the handle. The medication administration dose timer member has a curvilinear triangular shape and a turning needle for indicating the next dose time. The turning needle can be oriented in a specific direction to indicate the next dose time. The spoon reduces spilling of the medicine while giving medication to a patient.

In this manner, the medicine administering spoon of the present invention accomplishes all of the foregoing objectives and provides users with a specialized spoon for easily and conveniently administering medication. The spoon can be used to give medicine to sitting, supine, and moving patients. The bowl or spoon member reduces spilling of medication on clothing and face of the patient and the dose timer provides an indication of the next or subsequent dose timing. The spoon can be used for any type of oral medicine and can be used for both children and the elderly.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a liquid medication administration spoon. The spoon further comprising an elongated handle and a concave bowl or spoon member integrated at one end of the handle, the concave bowl or spoon member is used for accommodating medication for oral administration, and the concave bowl or spoon member featuring an elliptical-spoon-shaped periphery with curved contoured peripheral edges. A medication administration dose timer member is integrated at the opposing end of the handle. The medication administration dose timer member has a curvilinear triangular shape and a turning needle for indicating the next dose time. The curved contoured peripheral edges provide a plurality of curves for easy administration of oral medication to a patient wherein the patient is in any position. The turning needle can be oriented in a specific direction to indicate the next dose time.

In a further embodiment, a liquid medication administration spoon for administering liquid medication to a patient being in any position is disclosed. The spoon includes an elongated handle with an ergonomic design. A concave bowl or spoon member is at one end of the handle for accommodating medication. The concave bowl or spoon member has an elliptical-spoon-shaped periphery which has curved contoured peripheral edges for easy administration of liquid medication. The concave bowl or spoon member features a plurality of slit lines on the top surface thereof. Each slit line indicates a dose volume of medication. A medication administration dose timer member is integrated at a second end of the handle, the dose timer member has a curvilinear triangle shape and includes a turning needle for indicating the next scheduled dose time. The turning needle can be pointed to a position for indicating the time of the next dose.

In yet another embodiment, the spoon has a hole disposed near the curved edge of the dose timer to hang the spoon on a wall mounted hook.

In yet another embodiment, the dose timer member includes a plurality of different scheduled dose times including a morning dose time, an afternoon dose time, an evening dose time, and a night dose time, wherein a pointed end of the needle points to one of the dose times to indicate the next dose time.

In yet another embodiment, the bowl or spoon member has a pair of opposing curves for administering medicine to a supine patient and a distal curve for administering medicine to a sitting or a moving patient.

In another aspect of the present invention, the medication administration dose timer member is integrated at an angle that departs from the axis of the handle to prevent the unintentional disengagement or turning of the needle while using the spoon.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the liquid medication administration spoon of the present invention in accordance with the disclosed structure;

FIG. 2 illustrates a side view of the liquid medication administration spoon of the present invention in accordance with the disclosed structure;

FIG. 3 illustrates a perspective view showing the liquid medication administration spoon of the present invention being used for administering a medication to a patient in accordance with the disclosed structure;

FIG. 4 illustrates a perspective view showing the use of the liquid medication administration spoon of the present invention for administering a medication to a patient who is in a sitting position; and

FIG. 5 illustrates an enlarged view of another embodiment of the medication administration dose timer member used in the medication administering spoon of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a liquid medication administering device that allows easy administration of the liquid medicine. Additionally, there is a long-felt need in the art for a spoon specially designed to administer liquid medication to individuals who are in different positions. Moreover, there is a long-felt need in the art for an oral medication administration spoon that includes a clock face to visually aid patients and caregivers to keep track of the next medication dose. Further, there is a long-felt need in the art for a liquid medication administration spoon that reduces spilling of medication on clothing and face of the patient. Furthermore, there is a long-felt need in the art for an oral medication administration spoon that indicates dose volume for precise medication administration. Finally, there is a long felt need in the art for a liquid medication administration spoon that allows liquid medication administration to patients who are sitting up, supine, or moving around position while reducing the chances of spilling of medication by providing different contoured sides for easy administration.

The present invention, in one exemplary embodiment, is a liquid medication administration spoon for administering liquid medication to a patient. The spoon includes an ergonomic handle, and a concave bowl or spoon member for accommodating medicine. The concave bowl or spoon member has an elliptical-spoon-shaped periphery which has curved contoured peripheral edges for easy administration of liquid medication. The concave bowl or spoon member features a plurality of slit lines on the top surface thereof. Each slit line indicates a dose volume of medicine. A medication administration dose timer member is integrated at a second end of the handle, the dose timer member has a curvilinear triangle shape and includes a turning needle for indicating the next dose time. The turning needle can be pointed to a position for indicating the time of the next dose.

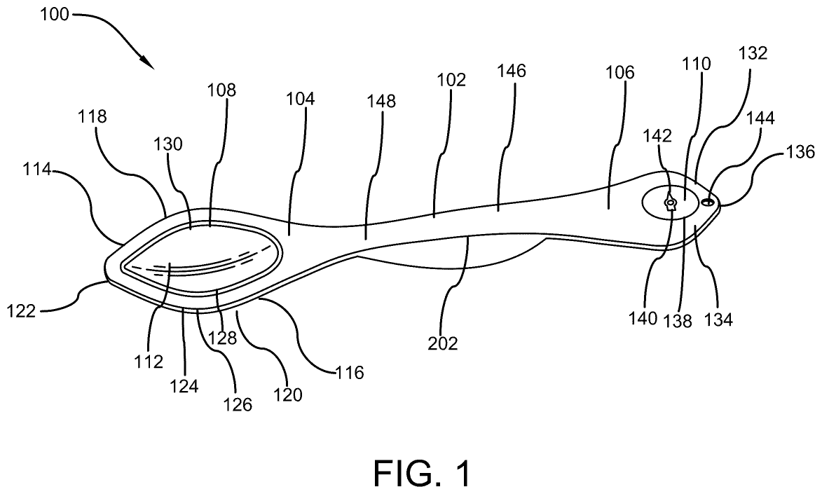

Referring initially to the drawings, FIG. 1 illustrates a perspective view of the liquid medication administration spoon of the present invention in accordance with the disclosed structure. The liquid medication administration spoon 100 of the present invention is designed for administering oral medication to patients (such as children and elderly) without any spilling of medication. More specifically, the spoon 100 can be used to give medication more precisely and conveniently regardless of the posture and position of the patient. The medication administration spoon 100 has an elongated handle 102 having a first end 104 and a second end 106 opposing to the first end 104. A bowl or spoon member 108 used for accommodating medication for oral administration is integrated to the first end 104 and a medication administration dose timer member 110 is integrated to the second end 106 of the handle 102. The handle 102 is ergonomic and can be easily held by a user in one hand for administering medication to a patient.

The bowl or spoon member 108 has a concave top surface 112 and has an elliptical-spoon-shaped periphery 126. The bowl or spoon member 108 has a first curved contoured peripheral edge 114 and a second curved contoured peripheral edge 116, the edges 114, 116 extend on opposing sides from the first end 104. The first curved contoured peripheral edge 114 has a curve 118 which can be used for administering medication placed in the bowl or spoon member 108. Similarly, the second curved contoured peripheral edge 116 has a symmetrical curve 120 to the curve 118 for administering medication. The distal end 122 of the bowl or spoon member 108 is also curved and the edges 114, 116 meet at the distal end 122. The edges 114, 116 have a lip 124 along the length thereof for preventing the medication from slippage from the bowl or spoon member 108.

The bowl or spoon member 108 has a plurality of slit lines 128, 130 disposed parallel to the periphery 126. The slit lines 128, 130 are designed to indicate different dose volumes of medication in the bowl or spoon member 108. It will be apparent to a person skilled in the art that in conventional spoons, accurately measuring dose volume is difficult especially when the dose volume is not in integral multiples of the spoon volume. In one embodiment, the slit line 128 defines one-half spoon dose and the slit line 130 defines three-fourths spoon dose. Based on requirements of the users, a plurality of slit lines defining different dose volumes can be disposed on the top surface 112 of the bowl or spoon member 108.

The medication administration dose timer member 110 has a curvilinear shape and includes two elongated sides 132, 134 and a curved side 136 connecting the elongated sides 132, 134. The elongated sides 132, 134 extend from the second end 106 of the handle 102. The top surface 138 of the dose timer member 110 includes a turning needle 140 which is configured to turn 360 degrees. The pointed end 142 of the needle 140 can be pointed in a specific direction (such as towards any of the sides 132, 134, 136, or towards the handle 102) indicating the next dose time. As an example, the pointed end 142 pointed towards the elongated side 132 may indicate the next dose in the afternoon. The use of dose timer member 110 can be customized by a user of the spoon 100 depending on the requirements.

A hole 144 is disposed near the curved edge 136 of the dose timer member 110 and is used for hanging the spoon 100 on a wall mounted hook or any other similar hanging means. The hole 144 enables a user to easily store the spoon 100 for easy accessibility and use. The top surface 146 of the handle 102 can have a logo or indicia 148 for marketing and branding purposes.

The spoon 100 can have a length of about 5-inches measuring between the distal end 122 of the bowl or spoon member 108 and curved edge 136 of the dose timer 110. The handle 102, preferably has a width of about 0.5 inches. The bowl portion 108 may have a width of about 1-inch between the curves 118, 120 for easy administration of the medication.

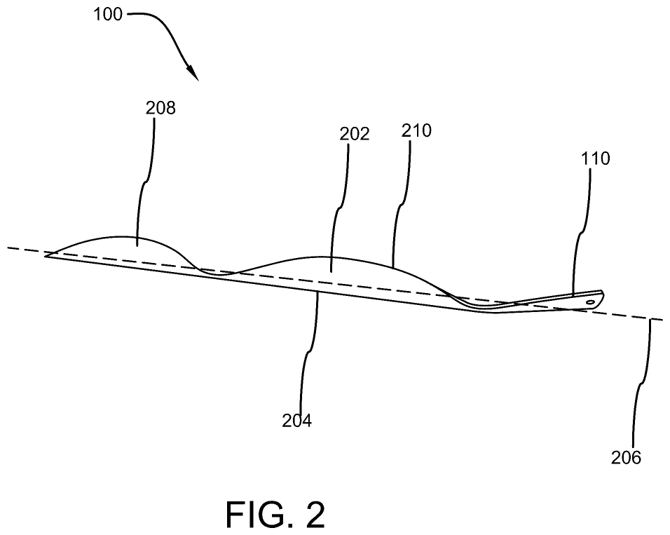

FIG. 2 illustrates a side view of the liquid medication administration spoon of the present invention in accordance with the disclosed structure. The handle 102 of the medication administration spoon 100 is designed to lie flat on a surface and includes side members 202 that extend backwards from the side edge 204 of the handle 102. In the side view, only one side member is shown, however, a similar side member extends from the other longitudinal side edge. The medication administration dose timer member 110 is integrated at an angle that departs from the axis 206 of the handle 102. This prevents the unintentional disengagement or turning of the needle 140 while using the spoon 100 and further, helps in easy mounting or hanging of the spoon 100.

In one exemplary embodiment, the rear surface 208 of the bowl or spoon member 108, the bottom edge 210 of the side member 202, and the curvilinear side 136 are coplanar allowing the spoon 100 to be kept flat on a surface. A liquid medication can be easily poured onto the bowl or spoon member 108 while the spoon 100 is kept on the surface with the top surface 112 facing away from the surface.

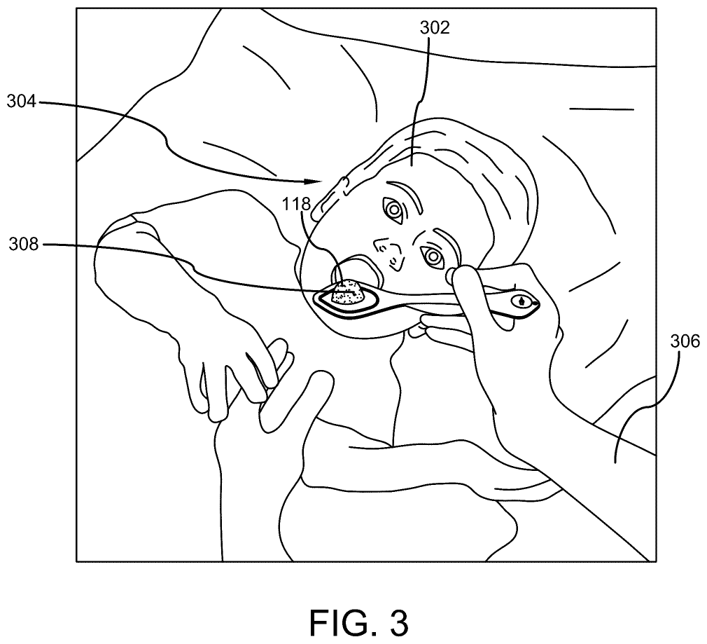

FIG. 3 illustrates a perspective view showing the liquid medication administration spoon of the present invention is used for administering a medication to a patient in accordance with the disclosed structure. In the present embodiment, the patient 302 is in a supine position 304 on a bed and a caretaker 306 holds the spoon 100 using the handle 102. Medication 308 is placed in the bowl portion 108 and is administered using the curve 118 of the bowl portion 108 for easy and convenient administration without any spillage.

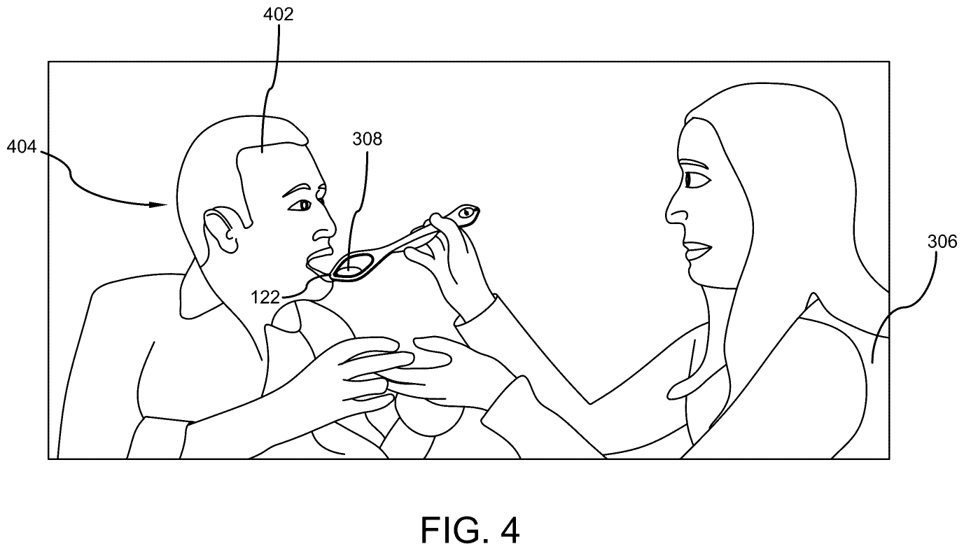

FIG. 4 illustrates a perspective view showing the use of the liquid medication administration spoon of the present invention for administering a medication to a patient who is in a sitting position. In the present embodiment, the patient 402 is in a sitting position 404 and the caretaker 306 administers the medication 308 using the distal curve 122 of the bowl or spoon member 108.

It will be apparent to a person skilled in the art that dose volume slit lines can be used for accurately providing medication to different patients and thus, the spoon 100 can be used for patients of all ages and genders.

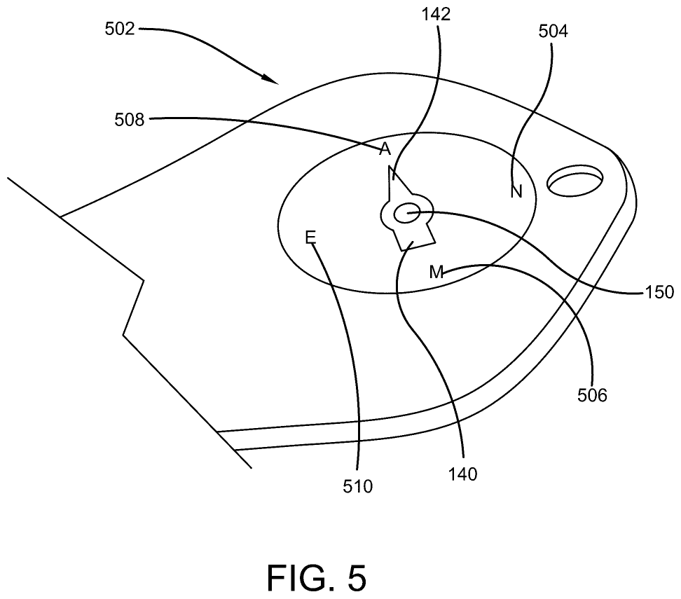

FIG. 5 illustrates an enlarged view of another embodiment of the medication administration dose timer member used in the medication administering spoon of the present invention in accordance with the disclosed structure. In the present embodiment, the medication administration dose timer member 502 includes dose timing symbols 504-510. As an example, the “M” symbol can indicate morning dose time, the “A” symbol can indicate afternoon dose time, the “E” symbol can indicate evening dose time, and the “N” symbol can indicate night dose time. Any other types of symbols can be included in the present invention without moving away from the scope of the present invention. The pointed end 142 can be pointed to any of the timing symbols 504-510 to indicate the next dose time for medication for a patient. As shown in FIGS. 1 and 5, the needle 140 is attached to a hinge or pivot 150 allowing the needle 140 to easily turn.

The liquid medication administration spoon 100 of the present invention can be made in any geometric shape and in any size. Further, the liquid medication administration spoon 100 can be made from safe and durable materials suitable for contact with medication and food, such as medical-grade plastics (e.g., polypropylene or polyethylene) or stainless steel. The material is chosen based on the cost, case of cleaning, and compatibility with the medication being administered. The spoon 100 is designed for administering oral medication to patients, including children and the elderly, with precision and convenience, regardless of the patient's posture and position. The slit lines on the bowl or spoon member help in accurately measuring different dose volumes of medication, even when the dose volume is not an integral multiple of the spoon's volume. The dose timer member assists in tracking and indicating the next dose time, making it easier for caregivers and patients to follow medication schedules.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “liquid medication administration spoon”, “medication administration spoon”, “spoon”, and “medicine administration spoon” are interchangeable and refer to the multifunctional medicine administration spoon 100 of the present invention.

Notwithstanding the foregoing, the multifunctional medicine administration spoon 100 of the present invention can be of any suitable size and configuration as is known in the art without affecting the overall concept of the invention, provided that it accomplishes the above-stated objectives. One of ordinary skill in the art will appreciate the multifunctional medicine administration spoon 100 as shown in the FIGS. 1-5 is for illustrative purposes only, and that many other sizes and shapes of the multifunctional medicine administration spoon 100 are well within the scope of the present disclosure. Although the dimensions of the multifunctional medicine administration spoon 100 are important design parameters for user convenience, the multifunctional medicine administration spoon 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid medication administration spoon for administering oral medication, the liquid medication administration spoon comprising:
a medication administration spoon having an elongated handle including a first end and an opposing second end;
wherein said first end having a spoon member for accommodating liquid medication therein;
wherein said second end having a medication administration dose timer member for indicating a time for a subsequent oral medication dose;
wherein said spoon member having a concave top surface and an elliptical shaped periphery including a first curved contoured peripheral edge and a second curved contoured peripheral edge, wherein said first curved contoured peripheral edge and said second curved contoured peripheral edge extending on opposing sides of said first end;
wherein said spoon member having a first slit line and at least a second slit line; and
further wherein said first slit line indicating a first volume of said spoon member and said at least second slit line indicating a second volume of said spoon member.

2. The liquid administration spoon of claim 1, wherein said first end having a terminal distal curved end connecting said first curved contoured peripheral edge and said second curved contoured peripheral edge.

3. The liquid administration spoon of claim 2, wherein said first curved contoured peripheral edge having a first lip and said second curved contoured peripheral edge having a second lip.

4. The liquid administration spoon of claim 3, wherein said first volume is a one-half spoon dose volume.

5. The liquid administration spoon of claim 4, wherein said second volume is a three-fourths spoon dose volume.

6. The liquid administration spoon of claim 5, wherein said timer member having a curvilinear shape including two elongated opposing sides and a curved terminal distal side connecting said elongated sides.

7. The liquid administration spoon of claim 6, wherein said timer member having a turning needle configured to turn 360-degrees including a pointed end to point to said time for the subsequent oral medication dose.

8. The liquid administration spoon of claim 7, wherein said first curved contoured peripheral edge symmetrical with said second curved contoured peripheral edge.

9. A liquid medication administration spoon for administering oral medication, the liquid medication administration spoon comprising:
a medication administration spoon having an elongated handle including a first end and an opposing second end;
wherein said first end having a spoon member for accommodating liquid medication therein;
wherein said spoon member having a concave top surface and an elliptical shaped periphery including a first curved contoured peripheral edge and a second curved contoured peripheral edge, wherein said first curved contoured peripheral edge and said second curved contoured peripheral edge extending on opposing sides of said first end;
wherein said spoon member having a rear surface and said handle having a pair of side members; and
further wherein said rear surface and said pair of side members are coplanar for holding said medication administration spoon horizontal on a flat surface.

10. The liquid administration spoon of claim 9, wherein said spoon member having a first slit line and at least a second slit line, and further wherein said first slit line indicating a first volume of said spoon member and said at least second slit line indicating a second volume of said spoon member.

11. The liquid administration spoon of claim 10, wherein said first end having a terminal distal curved end connecting said first curved contoured peripheral edge and said second curved contoured peripheral edge.

12. The liquid administration spoon of claim 11, wherein said first curved contoured peripheral edge having a first lip and said second curved contoured peripheral edge having a second lip.

13. The liquid administration spoon of claim 12, wherein said first volume is a one-half spoon dose volume.

14. The liquid administration spoon of claim 13, wherein said second volume is a three-fourths spoon dose volume.

15. The liquid administration spoon of claim 14, wherein said second end having a medication administration dose timer member for indicating a time for a subsequent oral medication dose, and further wherein said timer member having a curvilinear shape including two elongated opposing sides and a curved terminal distal side connecting said elongated sides.

16. The liquid administration spoon of claim 15, wherein said timer member having a turning needle configured to turn 360-degrees including a pointed end to point to said time for the subsequent oral medication dose.

17. The liquid administration spoon of claim 16, wherein said first curved contoured peripheral edge symmetrical with said second curved contoured peripheral edge.

18. A liquid medication administration spoon for administering oral medication, the liquid medication administration spoon comprising:
a medication administration spoon having an elongated handle including a first end and an opposing second end;
wherein said first end having a spoon member for accommodating liquid medication therein;
wherein said spoon member having a concave top surface and an elliptical shaped periphery including a first curved contoured peripheral edge and a second curved contoured peripheral edge, wherein said first curved contoured peripheral edge and said second curved contoured peripheral edge extending on opposing sides of said first end;
wherein said spoon member having a rear surface and said handle having a pair of side members;
wherein said rear surface and said pair of side members are coplanar for holding said medication administration spoon horizontal on a flat surface;
wherein said second end having a medication administration dose timer member for indicating a time for a subsequent oral medication dose; and
further wherein said time is selected from the group consisting of a “M” symbol for indicating a morning dose time, an “A” symbol for indicating an afternoon dose time, an “E” symbol for indicating an evening dose time, and an “N” symbol for indicating a night dose time.

19. The liquid administration spoon of claim 18, wherein said spoon member having a first slit line and at least a second slit line, and further wherein said first slit line indicating a first volume of said spoon member and said at least second slit line indicating a second volume of said spoon member.

20. The liquid administration spoon of claim 19, wherein said first volume is a one-half spoon dose volume, and further wherein said second volume is a three-fourths spoon dose volume.
